(19) United States
(12) Patent Application Publication
(10) Pub. No.: US 2017/0311121 A1
(43) Pub. Date: Oct. 26, 2017

(54) Mobile Geo-Localization System for Non-Static Environments

(71) Applicants: Saikat Dey, Birmingham, MI (US); Senni Perumal, Southfield, MI (US); Gerrit Reepmeyer, Novi, MI (US)

(72) Inventors: Saikat Dey, Birmingham, MI (US); Senni Perumal, Southfield, MI (US); Gerrit Reepmeyer, Novi, MI (US)

(21) Appl. No.: 15/136,815

(22) Filed: Apr. 22, 2016

(51) Int. Cl. H04W 4/02; H04W 84/18

(52) U.S. Cl. CPC H04W 4/021; H04W 84/18

(57) ABSTRACT

A mobile geo-localization system that uses an auto-calibration method to deliver accurate positioning data for humans and objects in non-static environments.

### BACKGROUND ART

### Field of the Invention

The invention relates to geo-localization systems that can be used in environments that have a mobile or non-static character. More particularly, the invention relates to temporal systems that spatially map environments for a specific function.

### Description of the Related Art

As of today, there are many different geo-localization technologies available in the market that allow accurate 1-dimensional (1-D), 2-D or 3-D tracking of humans or objects, for example, Ultra-Wide Band (UWB), differential GPS (dGPS), Wi-Fi, Bluetooth (BLE), RFID, cellular (3G, 4G/LTE), barometer, or Inertial Measurement Units (IMUs).

Current geo-localization systems almost always consist of two basic components: a static infrastructure of access points or devices that are installed in the area where the position tracking needs to happen, and mobile tags that are attached to the objects or humans that may or may not move and, as such, need to be tracked. By transmitting and receiving certain radio signals, the entire system can locate the position of each access point and/or each tag with varying degrees of accuracy depending on the geo-localization technology used. All of these systems, however, are reliant on the installation of fixed infrastructure transceiver devices.

Many environments that need geo-localization solutions allow for the time and efforts required to set up a respective network infrastructure to track positioning, such as office buildings, manufacturing plants, or any other static environment in which objects need to be tracked.

Over the recent past, however, geo-localization technology has seen an increase in potential demand in environments with a more mobile and non-static character, for example, tracking of objects or humans in emergency situations, construction sites, mobile industrial sites, or military applications. All of these environments are characterized by the fact that the nature of their configuration does not provide for the set-up of a stationary and static geo-localization infrastructure. Yet, all of these environments require some form of a network infrastructure in order for any geo-localization system to function.

### SUMMARY OF THE INVENTION

A method maps a defined space using a plurality of transceiver devices. The method initiates one of the plurality of transceiver devices to establish an infrastructure transceiver device. A portion of the plurality of transceiver devices are distributed to locations remote from the infrastructure transceiver device to create a plurality of secondary transceiver devices. Communication is established between the infrastructure transceiver device and each of the plurality of plurality of secondary devices. The location of each of the plurality of secondary devices within the defined space is identified to map the defined space.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is an environmental view of one embodiment of the invention deployed in a non-static environment;

FIG. 2 is a top view of FIG. 1;

FIG. 3 is a perspective of one embodiment of the invention deployed in an interior of a non-static environment;

FIG. 4 is a logic-diagram of one method incorporating the invention.

### DETAILED DESCRIPTION OF THE PREFERRED EMBODIMENT

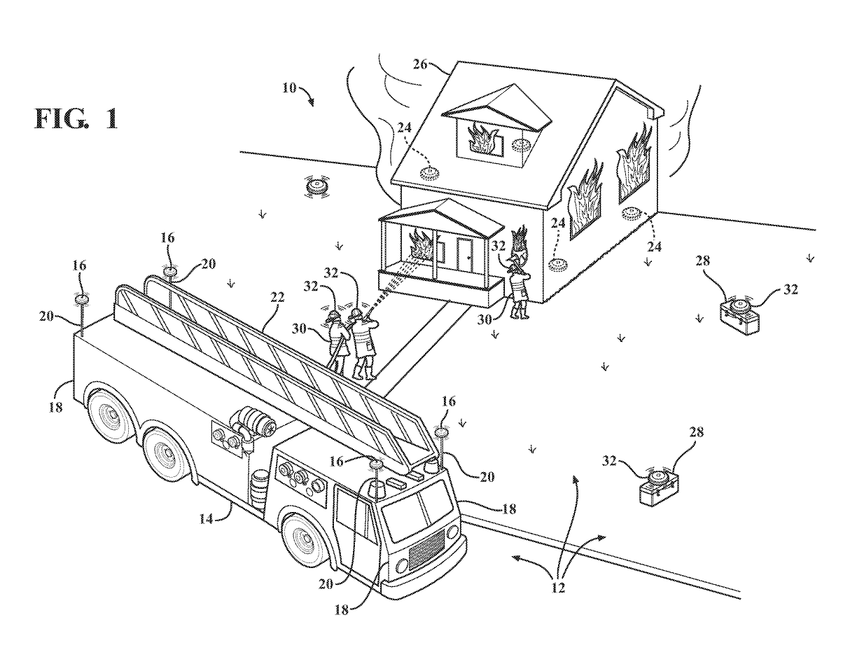

The set-up of a mobile geo-localization system in a non-static environment is illustrated in FIG. 1. For purposes of this disclosure, “non-static” may refer to either spatial or temporal variability, or both. By way of example, spatial variability may include a building that is being constructed, whereas temporal variability may include a space that is the subject of an emergency response so the requirement for mapping the space is only temporary.

FIG. 1 uses the example of a firefighting situation, but someone skilled in the art will understand that a similar system can also be installed in any other environment where the nature of its configuration does not allow for sufficient time or resources to build a static and stationary geo-localization system to track objects or humans. In addition to firefighting situations, examples for these environments could be zones of natural disasters (e.g., earthquakes, tsunamis, floods, volcano eruptions), construction sites, mobile industrial sites, military applications, or any other non-permanent situation or environment.

In situations when there is not sufficient time or economic reason to install a geo-localization infrastructure for whatever the reason, there is still a need to accurately tracking the position of humans or objects. For instance, knowing the position of a firefighter in a hazardous environment will significantly increase the likelihood of his or her survival. Identifying the location of a worker on a construction site or an industrial site can allow for increasing his or her personal safety. Finally, knowing the exact location of military equipment and soldiers will significantly improve warfare capabilities.

Referring back to FIG. 1, a non-static environment is a defined space and is generally indicated at 10. The non-static environment 10 has a geo-localization infrastructure assembly, generally indicated at 12, brought to the site only right before the geo-localization infrastructure assembly 12 should become active. This is illustrated in the firefighting situation in FIG. 1 by the fact that a portion of the geo-localization infrastructure assembly 12 is affixed to a mobile unit 14, embodied in a fire truck. In other environments as described above, the fire truck 14 could, for example, be replaced with a construction trailer, an industrial maintenance truck, or a military vehicle (for simplicity these cases are not graphically illustrated in FIG. 1) and not deviate from the inventive concept.

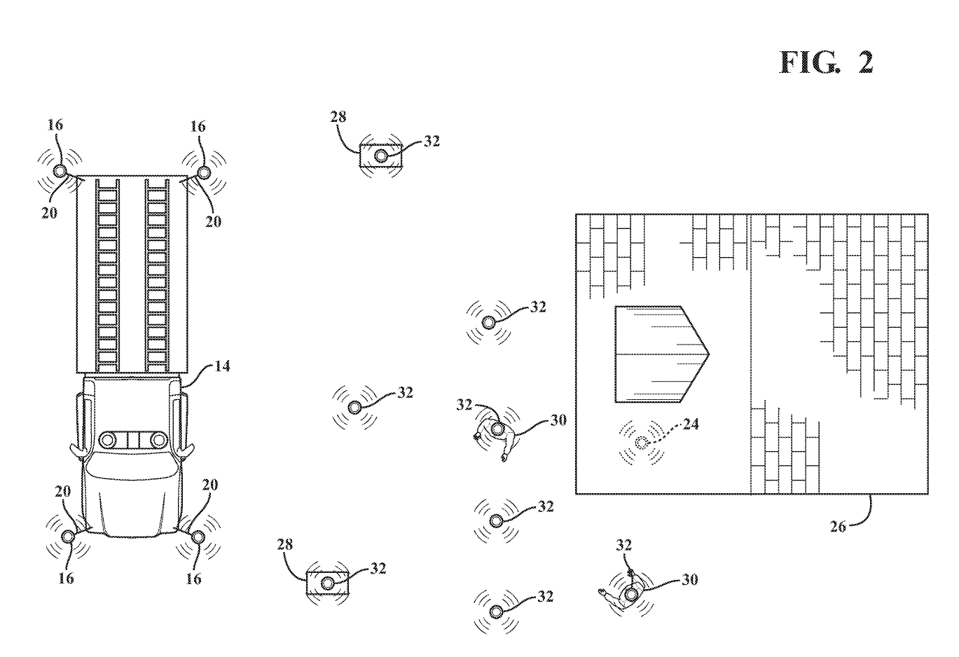

The geo-localization infrastructure assembly 12 includes a plurality of transceiver devices 16, 24, 32. One of the transceiver devices 16 is identified as an infrastructure transceiver device 16. In the embodiment shown in FIGS. 1 and 2, there are four infrastructure transceiver devices 16. Each infrastructure transceiver device 16 includes a transmitter and a receiver to transmit and receive signals from the other transceiver devices 16, 24, 32. Each infrastructure transceiver device 16 also has access to a power source, either a battery local to the infrastructure transceiver device 16 or a plug in connection to power source. At least one antenna is built into the infrastructure transceiver device 16.

In the embodiment shown in FIG. 1, the four infrastructure transceiver devices 16 are attached to a corner 18 of the firetruck 14. Although each of the infrastructure transceiver devices 16 is shown affixed to a telescoping extension 20, the infrastructure transceiver devices 16 may all be secured directly to the firetruck 14. Depending on the deployment, one infrastructure transceiver device 16 could also be secured to a ladder 22, if it is known that the ladder 22 can be deployed to a stationary position.

To that end, the infrastructure transceiver devices 16 are required to be temporarily static and are not allowed to be moved until the remainder of the geo-localization infrastructure assembly 12 is set-up and calibrated. Because of the mobile nature of the geo-localization infrastructure assembly 12, these infrastructure transceiver devices 16 are installed on the firetruck 14; however, the firetruck 14 needs to be parked and remain stationary until the remainder of the geo-localization infrastructure assembly 12 is set up.

The infrastructure transceiver devices 16 shall reach a certain level of elevation compared to the ground in order to provide for better connectivity. Securing each of the infrastructure transceiver device 16 to the end of the telescoping structures 20, especially when they are set at different heights, can provide for more accurate three-dimensional location data. Setting up these infrastructure transceiver devices 16 can be done very rapidly once the firetruck 14 or more generally, the mobile unit 14 has arrived at the site and has reached a temporarily static parking position.

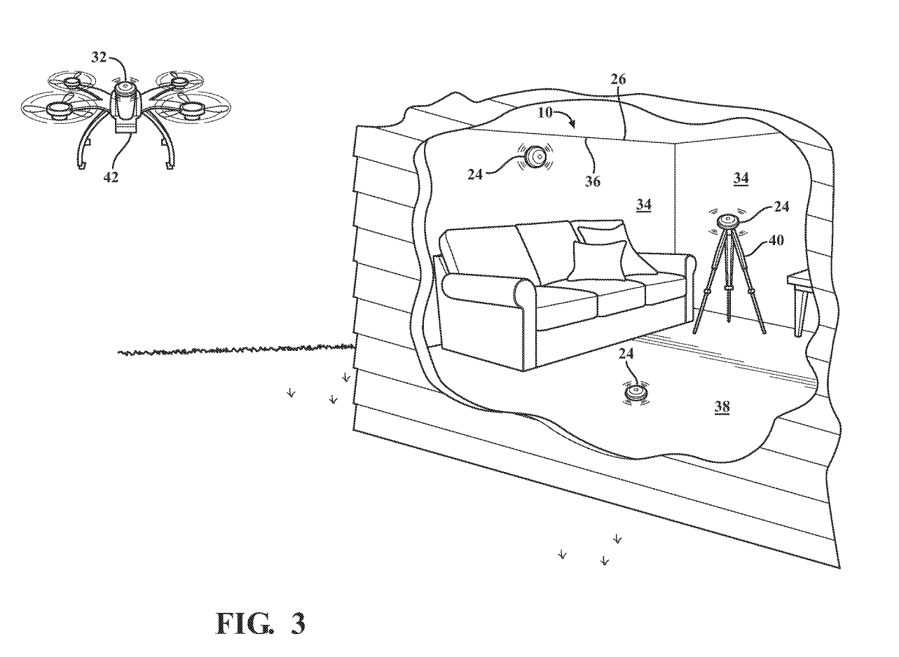

A second portion 24 of the transceiver devices define a plurality of secondary transceiver devices 24 that are distributed throughout the non-static environment 10. The plurality of secondary transceiver devices 24 are rolled out at the defined space 10 where objects or humans need to be tracked, for example a hazardous location such as a burning house 26 as illustrated in FIG. 1, or alternatively a construction site, an industrial site, or a battlefield situation. These secondary transceiver devices 24 can be rolled out easily by the workers or servicemen 30 who are entering the defined space 10. Various methods for rolling out the secondary transceiver devices 24 are described in more detail later in FIG. 3.

As illustrated in FIG. 1, the secondary devices can be placed either inside or outside a building 26. But depending on the technology used, they may need to have a direct line-of-sight (LOS) connection with another of the secondary transceiver devices 24. Additionally, at least one of the secondary transceiver devices 24 may require a direct LOS with at least one of the initial infrastructure transceiver devices 16, depending on the technology employed. Once the infrastructure 16 and secondary 24 transceiver devices have been rolled out, all of the transceiver devices 16, 24 can start communicating with each other by exchanging identifying signals, and the geo-localization infrastructure assembly 12 can start locating each of the transceiver devices 16, 24.

In addition to the transceiver devices 16, 24, objects 28 (e.g., certain pieces of equipment or containers) or humans 30 (e.g., workers, servicemen) can carry or be equipped with a second portion 32 of transceiver devices or tags 32 (e.g., attached to uniforms, personal protective equipment, or attached to the equipment itself). The newly established geo-localization infrastructure assembly 12 can start to locate the tags 32, i.e. workers, servicemen or equipment respectively. The method how the devices can rapidly and automatically be calibrated is described in more detail subsequently.

FIG. 2 shows a map-view of an exemplary, non-static site 10 where the positioning of the objects 32 or humans 30 needs to be tracked. For instance, the case in FIG. 2 illustrates that the firetruck 14 in FIG. 1 is parked in close proximity to a non-static site 10, such as a burning house 26. The infrastructure transceiver devices 16 are located at four defined locations 18 of the firetruck 14. One of these infrastructure transceiver devices 16 will function as the (0/0/0) coordinate for the positioning of all other transceiver devices 16, 24, 32 from a mapping perspective. It should be appreciated by those skilled in the art that there may be fewer than four infrastructure transceiver devices 16 and they may be located on the firetruck 14 at locations other than the at the corners 18.

The firetruck 14 in FIG. 2 therefore provides for the anchor point for the entire geo-localization infrastructure assembly 12. Once the infrastructure transceiver devices 16 have connected with the secondary devices 24, the secondary devices 24 as well as the objects 28 or humans 30 that carry corresponding tags 32 to identify their respective locations can now be located on the map as well. This includes an indication of their distance from both the firetruck 14 as well from each other respectively. The resulting map can then be monitored by a foreman, supervisor or some other manager in order to track the position of critical objects 28 or humans 30 on the site. Based on their respective location, the manager can take certain actions, such as searching for objects 28 or humans 30 in critical areas, removing objects 28 or humans 30 from critical areas, sending support workers, or even tracking people's exposures to certain environmental conditions. Depending on the time permissible to set up the defined space 10, the functionalities associated with the positioning data can be even more comprehensive and include, for example, geo-fencing or proximity detection functionalities.

Referring to FIG. 3, examples of secondary transceiver devices 24 secured to the defined space 10 and, more specifically the house 26, are shown. In general, there are many ways how a secondary transceiver device 24 may be affixed quickly to an existing building 26. Depending on the permissible setup time, any of the suggested approaches below can be selected. Some examples of methods to affix the secondary transceiver devices 24 can include, but are not limited to:

Self-adhesive (e.g., stuck to a wall 34 or ceiling 36)

Grounded (e.g., dropped to a floor 38)

Mounted (e.g., on top of a tripod 40 or other auxiliary device)

Floating (e.g., attached to a drone 42)

In some situations, such as firefighting, the servicemen 32 will not have a sufficient amount of time to mount secondary transceiver devices 24 to tripods 40 or similar auxiliary devices. In these situations, the self-adhesive approach to affix the secondary transceiver devices 24 might be better suited and provide for a faster set-up, for example, with a highly adhesive material. For such a method, the secondary transceiver device 24 would include a layer of the self-adhesive material (not shown). The workers 30 or servicemen 30 can carry the secondary transceiver devices 24 to attach them to walls 34 or ceilings 36. Once the secondary transceiver devices 24 are attached to the walls 34 and/or the ceiling 36, the secondary transceiver devices 24 will remain stationary at least for the duration of the assignment that needs to be completed by the respective workers 30 or servicemen 30. Such a secondary transceiver device 24 needs to be battery-driven.

When more setup time is permissible for the geo-localization infrastructure assembly 12, tripods 40 could provide for an alternative approach at, for example, construction or mobile industrial sites. Floating devices 42, such as drones, can be used in large areas that allow for direct line of sight (LOS) connectivity from higher levels of elevation, such as in open air spaces. Examples for the latter approach could be battlefields, or larger construction and industrial sites.

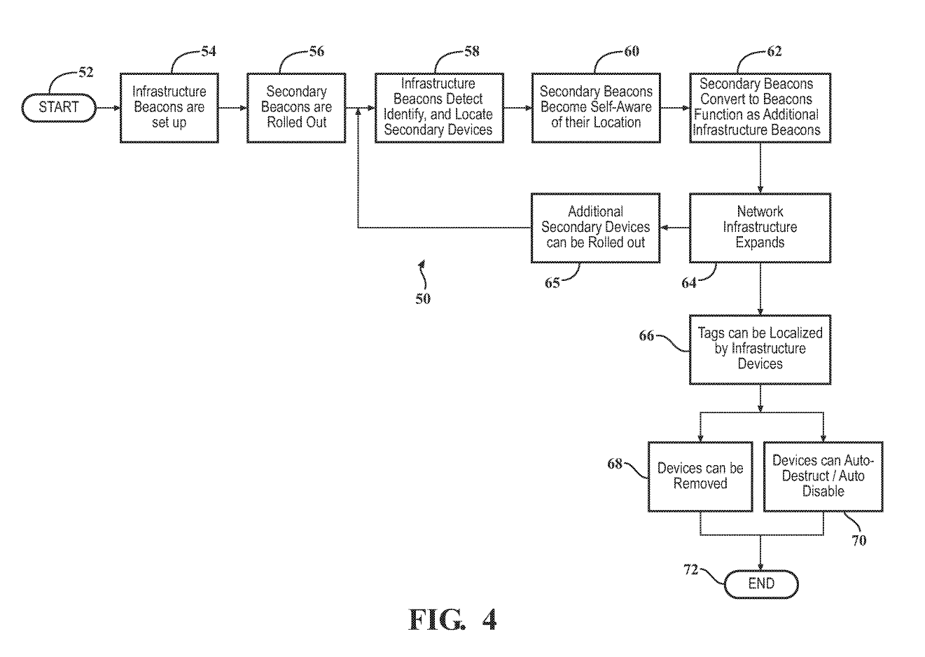

Referring to FIG. 4, one embodiment of the inventive method is shown at 50. The method 50 begins at 52. The infrastructure transceiver devices 16 are set up, including initiation and location processes, at 54. The secondary transceiver devices 24 are then rolled out at 56. The infrastructure transceiver devices 16 detect, identify and locate the secondary transceiver devices 24 at 58. Information regarding location are sent to each of the secondary transceiver devices 24, so they become self-aware of their location at 60.

In the instances when the secondary transceiver devices 24 are functionally as capable as the infrastructure transceiver devices 16, the secondary transceiver devices 24 transition into acting as infrastructure transceiver devices 16 after they become self-aware. This occurs at 62. When secondary devices 24 transition to infrastructure transceiver devices 16, the network infrastructure expands at 64. Additional secondary transceiver devices 24 are rolled out at 65 to expand the geo-localization infrastructure assembly 12. The second portion of transceiver devices or tags 32 can be located by the infrastructure 16 and secondary 24 transceiver devices at 66. After the assignment is terminated, the infrastructure 16 and secondary 24 transceiver devices can be removed at 68 or they can be destroyed and/or automatically disabled through an appropriate mechanism at 70. The method 50 terminates at 72.

Once the network infrastructure has been established and calibrated, and some, if not all, of the secondary transceiver devices 24 transition to infrastructure transceiver devices 16, the initial infrastructure transceiver devices 16 (i.e., those secured to firetruck 14) can be moved or relocated, with network infrastructure still being able to fully function and show the location of any infrastructure 16, secondary 24 or tertiary 32 device still activated within this non-static environment 10. The overall setup and calibration process can be done very rapidly and is expected to be completed within minutes.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

1. A method for mapping a defined space using a plurality of transceiver devices, the method comprising the steps of:
initiating one of the plurality of transceiver devices to establish an infrastructure transceiver device;
distributing a portion of the plurality of transceiver devices to locations remote from the infrastructure transceiver device to create a plurality of secondary transceiver devices;
establishing communication between the infrastructure transceiver device and each of the plurality of secondary devices;
identifying the location of each of the plurality of secondary devices within the defined space to map the defined space; and
transmitting the location of each of the plurality of secondary transceiver devices to each of the other secondary transceiver device such that each of the plurality of secondary transceiver devices operates as a secondary infrastructure transceiver device, each capable of operating as a new infrastructure transceiver device when the infrastructure transceiver device is removed from the defined space.

2. (canceled)

3. A method as set forth in claim 1 wherein the step of initiating the infrastructure transceiver device includes the step of locating the infrastructure transceiver device.

4. A method as set forth in claim 1 including the step of tracking a second portion of the plurality of transceiver devices as each moves through the defined space.

5. A method as set forth in claim 4 including the step of timing the second portion of the plurality of transceiver devices out such that the second portion of the plurality of transceiver devices ceases functioning after a predetermined time after deployment.

6. A method as set forth in claim 1 including the step of communicating with each of the plurality of secondary transceiver devices after a second predetermined time to determine whether any of the plurality of secondary transceiver devices has changed its location.

7. A method as set forth in claim 6 including the step of relocating each of the plurality of secondary transceiver devices when it is determined that one of the plurality of secondary transceiver devices has changed its location.

8. A method as set forth in claim 1 including the step of adhering a portion of the plurality of secondary transceiver devices to structures within the defined space.
